(19) United States
(12) Patent Application Publication
(10) Pub. No.: US 2026/0044384 A1
(43) Pub. Date: Feb. 12, 2026

(54) METHOD AND SYSTEM FOR DYNAMICALLY OPTIMIZING RESOURCE ALLOCATION IN A COMPUTATIONAL ENVIRONMENT

(71) Applicant: ProphetStor Data Services, Inc., Taichung (TW)

(72) Inventors: Wen-Shyen Chen, Taichung City (TW); Li-Wen Chen, Cupertino, CA (US); Ming-Jye Sheu, Saratoga, CA (US)

(21) Appl. No.: 18/796,787

(22) Filed: Aug. 7, 2024

(51) Int. Cl. G06F 9/50

(52) U.S. Cl. CPC G06F 9/5055; G06F 9/5038

(57) ABSTRACT

A method for dynamically optimizing resource allocation in a computational environment and a system thereof includes the steps of: collecting current state data of resources; calculating minimum computing power required to satisfy all workloads over time based on the state data transition using dynamic programming; generating an allocation table to represent workloads across time slots for each resource, based on the collected current state data and the calculated minimum computing power; determining whether to allocate a predicted workload within current allocation across various time slots or to reallocate workloads over an extended number of time slots to fulfill future resource demand of the predicted workload, based on which option requires less additional computing power; and dynamically adjusting resource allocations across the time slots based on the allocation decision of the predicted workload and the future resource demands of the predicted workload to optimize resource efficiency and minimize operational costs.

### FIELD OF THE INVENTION

The present invention relates to a method and a system for optimizing resource allocation. More particularly, the present invention relates to a method and a system for dynamically optimizing resource allocation in a computational environment using time-series predictions, ensuring optimal utilization and minimal waste by taking into account the entire execution timeline of workloads.

### BACKGROUND OF THE INVENTION

The efficient allocation of computing resources, particularly GPU resources, is pivotal for the optimal performance of modern computing environments, including cloud computing platforms and data centers. Traditionally, resource allocation has relied on static bin packing algorithms that assume workload sizes and demands remain constant. However, in dynamic environments, such as those affected by user behavior, varying application needs, or fluctuating demands throughout the day, these static approaches falter.

These challenges manifest in several critical ways. Firstly, existing algorithms often struggle to adapt to changing workload demands, leading to underutilization of GPUs or bottlenecks that degrade overall system performance. Secondly, without mechanisms to predict future resource requirements, traditional frameworks find it difficult to adjust resource allocations proactively. Consequently, systems frequently allocate either excessive or insufficient resources to tasks, resulting in inefficiencies, increased costs, and reduced cost-effectiveness.

For instance, U.S. Pat. No. 8,839,049, entitled “Dynamically allocating multitier applications based upon application requirements and performance reliability of resources,” addresses dynamic allocation based on performance and resource reliability. Similarly, U.S. Pub. No. 2021/0253376, entitled “System and method for autonomous multi-bin parcel loading system,” discloses a method for autonomous multi-bin parcel loading that handles online object packing without prior information on object dimensions. However, both lack consideration of the aforementioned critical challenges.

To tackle these issues, the present invention provides a Time Series Dynamic Programming Bin Packing (TS-DPBP) method which offers a dynamic and predictive framework. It adjusts GPU allocations based on both current and forecasted workload demands, leveraging time-series analysis to anticipate future resource needs accurately. This innovative approach enables proactive resource management, crucial for maintaining operational efficiency and cost-effectiveness in fast-paced, resource-intensive computing environments.

By dynamically adjusting resource allocations across different time slots, the present invention optimizes GPU utilization, effectively addressing the challenges posed by varying demands in large-scale data processing and cloud services. This adaptive strategy not only enhances system performance but also minimizes wastage and delays, ultimately leading to more efficient and economical utilization of computing resources.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims. The following presents a simplified summary of one or more aspects of the present disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

The present invention introduces a Time Series Dynamic Programming Bin Packing (TS-DPBP) method, a solution designed to optimize resource allocation, specifically designed to optimize GPU resources in environments with fluctuating demands, such as those encountered in training Large Language Models (LLMs) by integrating the temporal dimension. Unlike traditional static allocation methods, the present invention integrates temporal considerations into its framework, allowing for adaptive adjustments across multiple time slots. This capability is particularly crucial for sectors like cloud computing and data centers, where efficient GPU utilization directly impacts performance and cost efficiency.

At its core, the present invention leverages sophisticated time-series predictive analytics to forecast future resource requirements based on historical usage patterns. By dynamically reallocating GPU resources in response to predicted demands, the algorithm effectively mitigates the risk of underutilization or overutilization, thereby optimizing performance and reducing operational costs. This proactive approach not only enhances system efficiency but also contributes significantly to energy conservation efforts in data centers by minimizing the electricity consumed by underused GPUs and reducing associated cooling requirements.

In practical terms, the present invention ensures stable and efficient operations even during peak loads, thereby alleviating infrastructural strain and enhancing overall system reliability. Beyond energy savings, this innovative methodology enhances scalability and responsiveness in technology infrastructure by maximizing resource utilization, thereby reducing the physical space required for servers and alleviating network stress. This holistic approach to resource management not only advances sustainability goals but also drives down operational costs while improving the scalability and performance consistency of computational environments.

In summary, the present invention represents a paradigm shift in resource allocation methodologies, particularly beneficial for dynamic and intensive computing tasks like LLM training. By integrating dynamic programming with predictive analytics, it sets a new standard in computational resource management, offering a robust solution to the challenges posed by varying workloads in modern computing environments.

In one aspect, the present invention provides a method for dynamically optimizing resource allocation in a computational environment which includes the steps of: collecting current state data of resources within the computational environment; calculating minimum computing power required to satisfy all workloads over time based on the state data transition using dynamic programming; generating an allocation table, a three-dimensional array, to represent workloads across time slots for each resource, based on the collected current state data and the calculated minimum computing power, wherein each cell in the allocation table indicates resource utilization of a specific workload during the corresponding time slot; determining whether to allocate a predicted workload within current allocation across various time slots or to reallocate workloads over an extended number of time slots to fulfill future resource demand of the predicted workload, based on which option requires less additional computing power; and dynamically adjusting resource allocations across the time slots based on the allocation decision of the predicted workload and the future resource demands of the predicted workload to optimize resource efficiency and minimize operational costs.

Preferably, the future resource demands are predicted by collecting and analyzing current and historical resource usage data and trends using time-series predictive analysis.

Preferably, the resource allocations are adjusted based on a workload/resource demand matrix of workloads at different time slots and the allocation table, both of which are dynamically updated after the adjustment of resource allocations to detail workloads across different time slots for each resource in real-time.

Preferably, each resource is subdivided into virtual units and individually listed in the allocation table to display the workload for each time slot within each virtual unit.

Preferably, each time slot represents a distinct decision point, where decisions are made based on state transition logic that combines the current state with predicted future states.

Preferably, the current state data includes resource allocation, available resource capacity, total number of time slots, total number of workloads, and resource demand of each workload per time slot at the time the data is collected.

Preferably, the allocation decision is determined by comparing the minimum additional computing power needed to accommodate a new workload across all time slots with the minimum additional computing power required to reallocate all workloads from one time slot to another, while also considering the extra cost of placing the same workload in different resources across various time slots.

Preferably, the workloads are allocated using a bin-packing like process applied to a time-series.

Preferably, the computing power includes the sum of resources used, relocation cost, and re-scaling cost.

Preferably, the resources within the computational environment include GPUs, CPUs, memories, storage devices, virtual machines and containers, software resources, and cloud resources.

In another aspect, the present invention provides a system for dynamically optimizing resource allocation in a computational environment which includes: a plurality of resources within the computational environment; a data collecting module, connected to the plurality of resources, for continuously collecting current state data of resources within the computational environment in real-time; a workload prediction module, connected to the data collecting module, for predicting future resource demands of a predicted workload; a management module, connected to the data collecting module and the workload prediction module, for calculating minimum computing power required to satisfy all workloads over time based on the state data transition using dynamic programming; generating an allocation table, a three-dimensional array, to represent workloads across time slots for each resource, based on the collected current state data and the calculated minimum computing power, wherein each cell in the allocation table indicates resource utilization of a specific workload during the corresponding time slot; and determining whether to allocate the predicted workload within current allocation across various time slots or to reallocate workloads over an extended number of time slots to fulfill future resource demand of the predicted workload, based on which option requires less additional computing power; and a dynamic adjustment module, connected to both the management module and the data collecting module, for dynamically adjusting resource allocations across the time slots based on the allocation decision of the predicted workload and the future resource demands of the predicted workload, to optimize resource efficiency and minimize operational costs.

Preferably, the future resource demands are predicted by collecting and analyzing current and historical resource usage data and trends using time-series predictive analysis.

Preferably, the resource allocations are adjusted based on a workload/resource demand matrix of workloads at different time slots and the allocation table, both of which are dynamically updated after the adjustment of resource allocations to detail workloads across different time slots for each resource in real-time.

Preferably, each resource is subdivided into virtual units and individually listed in the allocation table to display the workload for each time slot within each virtual unit.

Preferably, each time slot represents a distinct decision point, where decisions are made based on state transition logic that combines the current state with predicted future states.

Preferably, the current state data includes resource allocation, available resource capacity, total number of time slots, total number of workloads, and resource demand of each workload per time slot at the time the data is collected.

Preferably, the allocation decision is determined by comparing the minimum additional computing power needed to accommodate a new workload across all time slots with the minimum additional computing power required to reallocate all workloads from one time slot to another, while also considering the extra cost of placing the same workload in different resources across various time slots.

Preferably, the workloads are allocated using a bin-packing process applied to a time-series.

Preferably, the computing power includes the sum of resources used, relocation cost, and re-scaling cost.

Preferably, the resources within the computational environment include GPUs, CPUs, memories, storage devices, virtual machines and containers, software resources, and cloud resources.

### BRIEF DESCRIPTION OF THE DRAWINGS

FIG. 1 is a block diagram illustrating major components of a system for dynamically optimizing resource allocation in a computational environment according to an embodiment of the present invention.

FIGS. 2(a) and 2(b) are flowcharts illustrating a method for dynamically optimizing resource allocation in a computational environment according to an embodiment of the present invention.

FIG. 3(a) illustrates an exemplary flow chart detailing the step-by-step process of dynamic programming; FIG. 3(b) presents a conceptual diagram depicting state transitions within the dynamic programming framework; and FIG. 3(c) offers a conceptual diagram showcasing the recursive computation involved in dynamic programming.

FIG. 4 is an example of an allocation table according to an embodiment of the present invention.

FIGS. 5(a) and 5(b) are conceptual overviews of resource allocation in a multi-time slot environment according to an embodiment of the present invention.

### DETAILED DESCRIPTION OF THE PREFERRED EMBODIMENTS

The present invention will now be described more specifically with reference to the following embodiments. The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

The present invention introduces several key improvements over existing strategies. It enhances flexibility by dynamically adjusting to changing demands, a capability lacking in traditional bin packing algorithms. By optimizing resource allocation and minimizing wastage, it effectively reduces operational costs, including energy consumption and the need for excess capacity. The algorithm maintains scalability even with large-scale computational tasks, making it ideal for enterprises managing extensive data centers or cloud platforms. Moreover, the present invention employs proactive resource management through predictive capabilities, ensuring improved system responsiveness and user satisfaction compared to reactive approaches used by most existing algorithms. Overall, the present invention represents a more flexible, efficient, and predictive solution for resource management in modern computational environments.

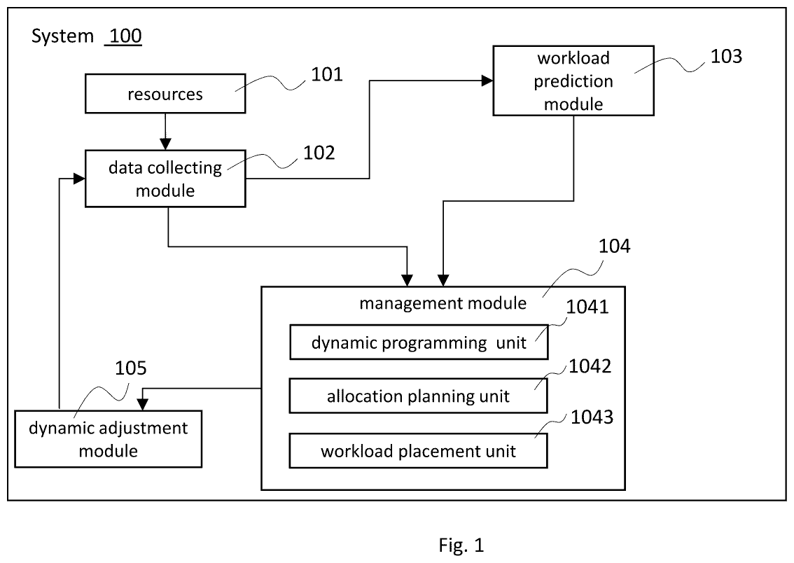

FIG. 1 is a block diagram illustrating major components of a system 100 for dynamically optimizing resource allocation in a computational environment according to an embodiment of the present invention. The present invention provides a system 100 for dynamically optimizing resource allocation in a computational environment. The computational environment encompasses a collection of computer machinery, data storage devices, workstations, software applications, and networks. Together, these components support the processing and exchange of electronic information required by the software solution (i.e., workloads). This system 100 includes multiple resources 101, such as GPUs, CPUs, memory, storage devices, virtual machines, containers, software resources, and cloud resources. These resources 101 are managed in real-time by a data collecting module 102, which continuously gathers current state data from the computational environment. The system 100 also features a workload prediction module 103, connected to the data collecting module 102, which forecasts future resource demands of a predicted workload based on current and historical data trends using time-series predictive analysis.

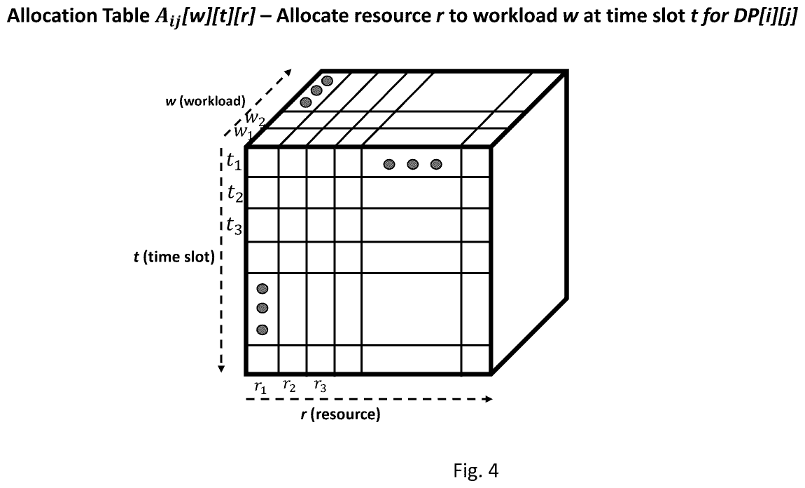

The core of the system 100 is a management module 104, which is linked to both the data collecting module 102 and the workload prediction module 103. The management module 104 includes several key units: a dynamic programming unit 1041, an allocation planning unit 1042, and a workload placement unit 1043, each linked to one another. The dynamic programming unit 1041 computes the minimum computing power required to satisfy all workloads over time using dynamic programming based on the state data transition. The goal of the dynamic programming framework is to minimize a cost function that incorporates factors such as resource utilization efficiency, operational costs, and penalties for not meeting service level agreements (SLAs). The dynamic programming unit 1041 also evaluates whether to allocate additional predicted workload within the current allocation or to reallocate workloads over an extended number of time slots, based on which option requires less additional computing power. Next, the allocation planning unit 1042 constructs an allocation table-a three-dimensional array—that represents workloads across time slots for each resource, as shown in FIG. 4, based on the calculation results of the dynamic programming unit 1041. Each cell in this allocation table indicates the resource utilization for a specific workload during the corresponding time slot. The workload placement unit 1043 then allocates resources to the predicted workload based on the allocation table dynamically generated by the allocation planning unit 1042.

A dynamic adjustment module 105 is connected to both the management module 104 and the data collecting module 102 to implement real-time adjustments in resource allocations based on the allocation decisions and predicted future demands. This module aims to optimize resource efficiency and minimize operational costs. The resource allocations are continuously updated based on a dynamically evolving workload/resource demand matrix and the allocation table. This is achieved through real-time data collection by the data collecting module 102 and refined workload predictions by the workload prediction module 103. The dynamic adjustment module 105 will leverage techniques such as dynamic time warping to evaluate the accuracy of the workload prediction against actual run-time data, determining whether a recalculation of the workload prediction is necessary. For a better understanding of “dynamic time warping,” refer to Eamonn Keogh and M. Pazzani's paper, “Derivative Dynamic Time Warping,” presented at the First SIAM International Conference on Data Mining (SDM 2001).

Each resource 101 is subdivided into virtual units, which are individually listed in the allocation table to detail the workload for each time slot within each virtual unit. In other words, the resources 101 are dynamically partitioned and allocated based on changing workload demands. This adaptive resource partitioning is crucial for maximizing resource utilization and minimizing contention between concurrent tasks.

The resources 101 may include but not limited to GPU (Graphics Processing Unit), CPU (Central Processing Unit), memory (RAM—Random Access Memory), storage devices including HDDs (Hard Disk Drives) and SSDs (Solid State Drives), virtual machines/containers, software resources including operating systems, middleware, database management systems, and application software, and cloud resources provided by cloud service providers including compute instances, storage, and managed services.

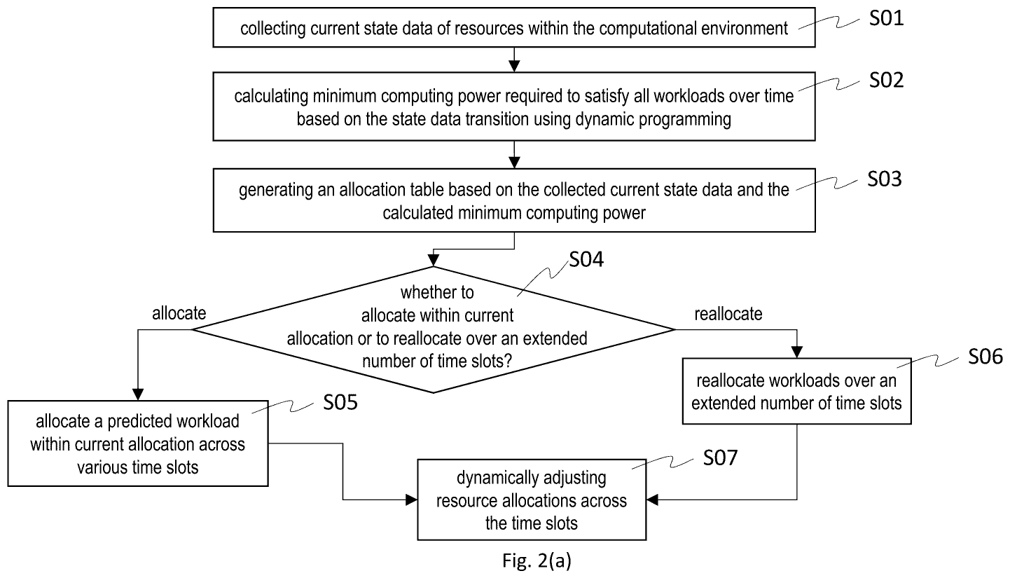

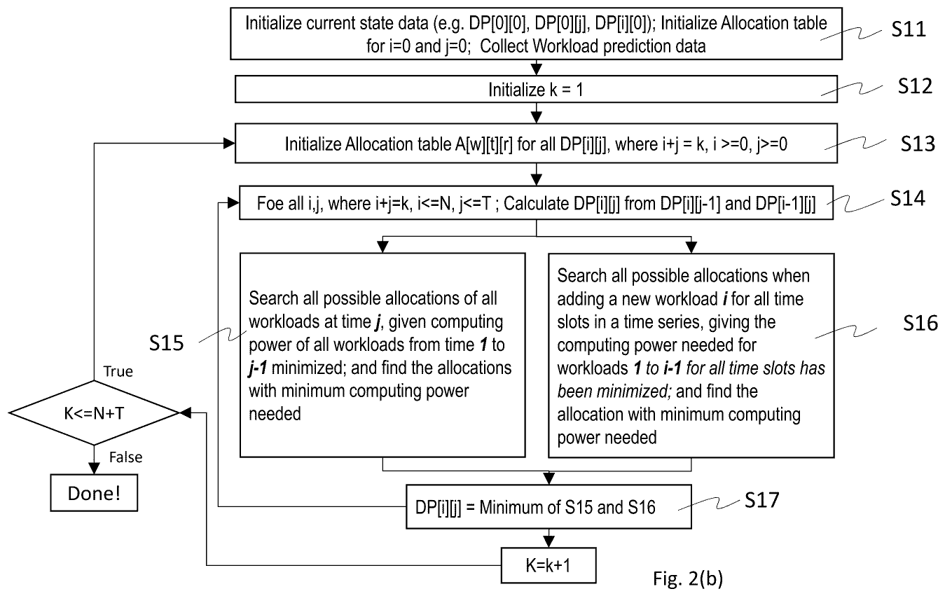

For a better understanding of the present invention, please refer to FIGS. 2(a) and 2(b) which are flowcharts illustrating a method for dynamically optimizing resource allocation in a computational environment according to an embodiment of the present invention. FIG. 2(a) provides an overview of the method, while FIG. 2(b) presents a detailed flow chart of steps S02 to S06 as depicted in FIG. 2(a). The method includes several key steps designed to optimize efficiency and minimize operational costs.

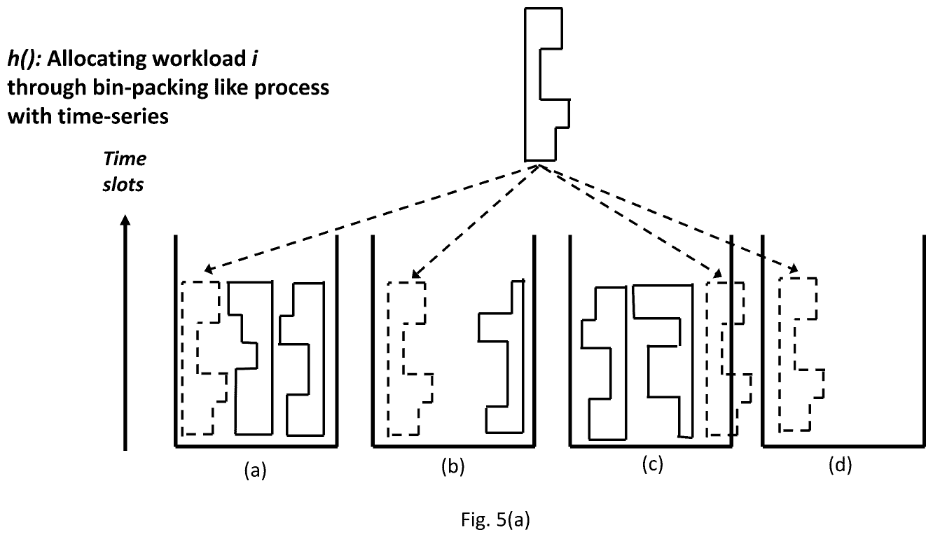

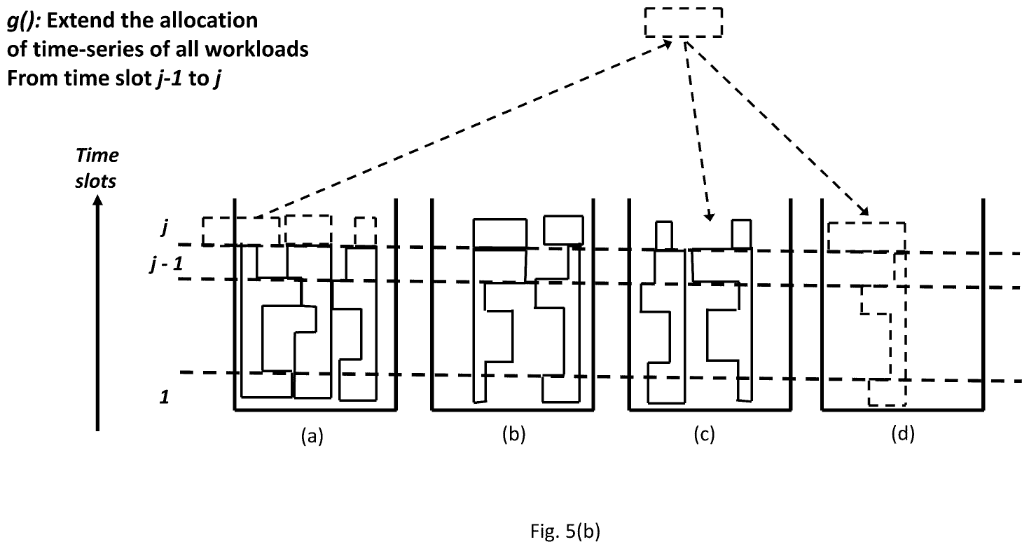

First, current state data of resources 101 is collected by the data collecting module 102 (step S01). Then, the dynamic programming unit 1041 determines the minimum computing power required to satisfy all workloads over time using dynamic programming (step S02). Based on this data, the allocation planning unit 1042 creates an allocation table to represent workloads across time slots for each resource, as shown in FIG. 4 (step S03). The dynamic programming unit 1041 also evaluates whether to allocate a predicted workload within the current allocation or to reallocate workloads over extended time slots based on which option needs less additional computing power (step S04). If the decision favors the current allocation, the predicted workload is allocated accordingly, as shown in FIG. 5(a) (step S05); otherwise, workloads are reallocated to fulfill future demands, as shown in FIG. 5(b) (step S06). Finally, the dynamic adjustment module 105 dynamically adjusts resource allocations across the time slots to optimize resource efficiency and minimize operational costs (step S07).

The current state data includes details such as resource allocation, available resource capacity, total number of time slots, total number of workloads, and resource demand per workload per time slot at the time the data is collected. Each time slot acts as a decision point where choices are made based on state transition logic that combines the current state with predicted future states. The allocation decision is made by comparing the minimum additional computing power needed to accommodate a new workload across all time slots with the power required to reallocate all workloads from one time slot to another, factoring in the extra cost of placing the same workload in different resources across various time slots. Workloads are allocated using a bin-packing process applied to a time-series, considering the total computing power required, including resources used, relocation cost, and re-scaling cost.

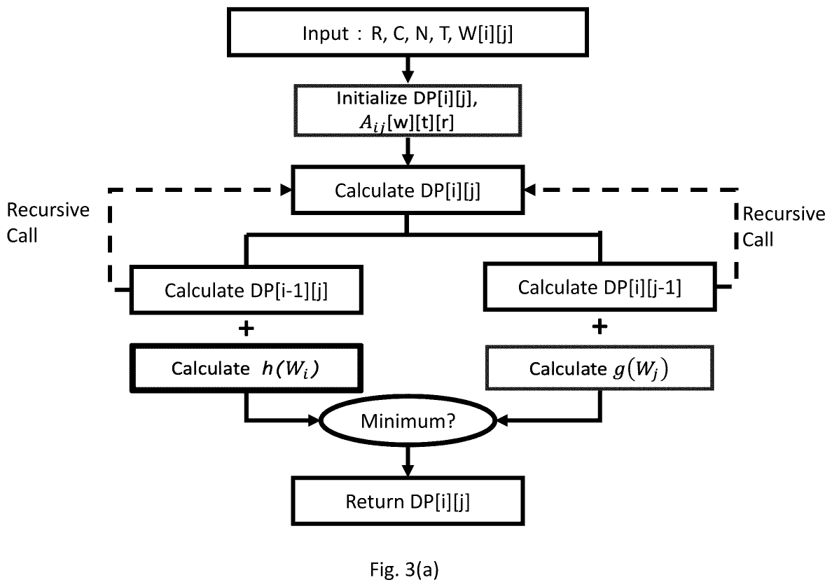

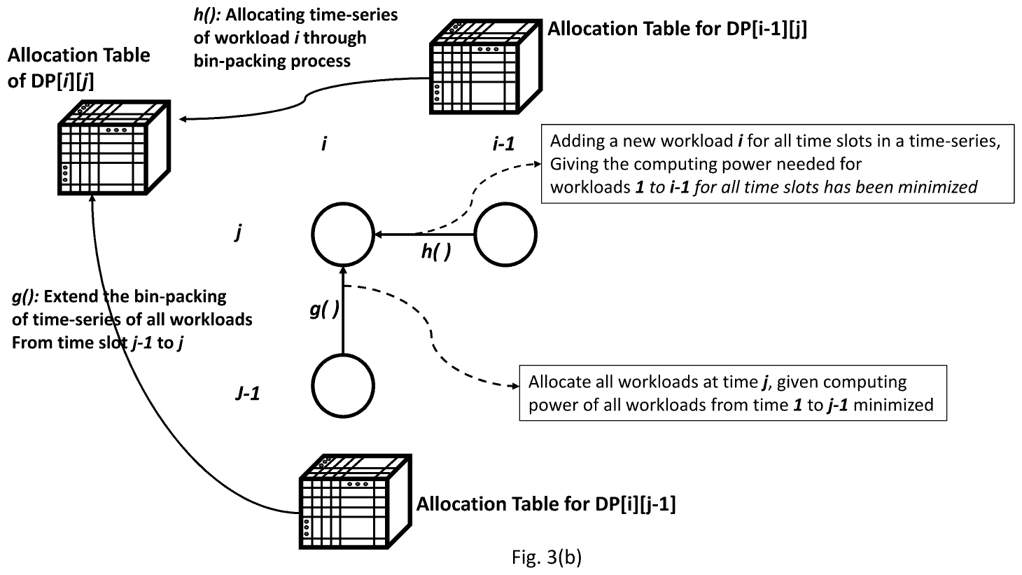

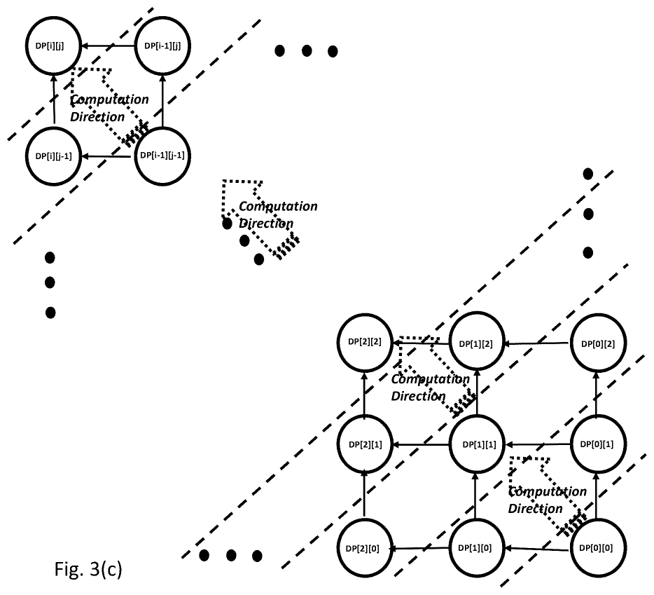

For a clearer understanding of the calculations performed by the dynamic programming unit 1041, please refer to FIG. 2(b). The current state data and the allocation table is first initialized (steps S11˜S13). Then, a dynamic programming process is performed, as shown in FIGS. 3(b) and 3(c) (step S14). According to the present embodiment, the dynamic programming unit 1041 explores two possible options by the dynamic programming process: one involves adding a new workload to the existing allocation (step S05 in FIG. 2(a) and step S16 in FIG. 2(b)), while the other progresses by moving forward one time slot (step S06 in FIG. 2(a) and step S15 in FIG. 2(b)). In the first case, all possible allocations for adding a new workload i across all time slots in a time series are searched, ensuring that the computing power needed for workloads 1 to i in all time slots is minimized. The allocation with the minimum computing power requirement will be selected, as illustrated in FIG. 5(b) (step S16). In the second case, all possible allocations for all workloads at time slot j are searched, ensuring that the computing power for all workloads from time slots 1 to j is minimized. The allocation with the minimum computing power requirement will be selected, as shown in FIG. 5(a) (step S15). Finally, the results from steps S15 and S16 are compared, and the one with the minimum computing power requirement is selected (step S17).

Please refer to FIGS. 3(a) to 3(c) and FIG. 4. FIG. 3(a) illustrates an exemplary flow chart detailing the step-by-step process of dynamic programming and provides a more simplified version of FIG. 2(b); FIG. 3(b) presents a conceptual diagram depicting state transitions within the dynamic programming framework; and FIG. 3(c) offers a conceptual diagram showcasing the recursive computation involved in dynamic programming. FIG. 4 is an example of an allocation table according to an embodiment of the present invention. The flow chart includes decision points, state transitions, and the criteria for transitioning from one state to another based on predictive analysis of future resource demands.

In this embodiment, the system 100 is assumed to be homogeneous, with R denoting the number of available resources (e.g., GPUs) and each resource's capacity denoted as C. Each resource can be subdivided into virtual resources, such as Multi-Instance GPUs (MIG), with up to seven units per resource. T represents the total number of time slots, while N denotes the total number of workloads. The resource demand of workload i at time j is represented by W[i][j], where i ranges from 1 to N and j from 1 to T. The minimum computing power needed to accommodate all workloads from the first workload to the ith workload, across time slots from 1 to j, is denoted by DP[i][j]. The portion of resource r allocated to workload w at time slot t, after reaching the DP[i][j] state through the dynamic programming process, is represented by Aij[w][t][r]. The function h(Wi) determines the minimum additional computing power required to add a new workload i across all time slots from 1 to j by calculating the resources needed to extend all workload allocations from time j−1 to time j from the existing allocation, plus any extra cost if the same workload must be placed in different resources across various time slots. Similarly, the function g(Wj) determines the minimum additional computing power required to allocate all workloads from 1 to i at time slot j by calculating the resources needed to add a new workload i, along with its entire time series from time 1 to time j, from the current allocation, plus any extra cost if the same workload must be placed in different resources across various time slots. Time series is a sequence of various data points that occurred in a successive order for a given period of time.

FIGS. 5(a) and 5(b) provide conceptual overviews of resource allocation in a multi-time slot environment according to an embodiment of the present invention. These figures include a series of sub-diagrams that visualize the allocation of resources across multiple time slots. Each sub-diagram represents a different scenario or phase in the workload lifecycle, demonstrating how resources are dynamically allocated and adjusted in response to changing demands. FIG. 5(a) illustrates the optimization of allocating a new workload across the entire time series, while FIG. 5(b) shows the extension of all workloads to a new time slot j within the existing allocation framework up to that time slot.

Comparison Table: TS-DPBP vs. Traditional Bin-Packing

| | TS-DPBP (Dynamic | Traditional Bin-Packing |
|---|---|---|
| Feature/Aspect | Programming Approach) | Algorithm |
| Objective | Minimize the total number of | Minimize the number of bins |
| | GPUs used over time, satisfying | (containers) used. |
| | each workload's demand at | |
| | every time slot. | |
| Algorithmic | Utilizes dynamic programming | Typically employs greedy |
| Approach | to iteratively calculate the | methods, like First Fit or Best |
| | minimum GPUs required for | Fit, to pack items into the |
| | subsets of workloads across | least number of bins. |
| | time slots. | |
| Complexity | Higher due to the need to | Lower, focused on spatially |
| | consider the temporal | packing items without |
| | dimension and dynamic | considering time. |
| | workload demands. | |
| Penalty for | Incorporates a penalty | Not applicable, as there's no |
| Reallocations | function for reallocating | concept of reallocating |
| | resources across time slots to | resources over time. |
| | reflect real-world costs. | |
| Application | Suitable for dynamic | Best suited for static |
| Scenarios | environments with fluctuating | scenarios where the goal is |
| | demands over time, such as | to optimize spatial |
| | cloud computing resources | utilization, like packing |
| | allocation. | goods for shipping. |
| Implementation | Requires sophisticated | Implementation focuses on |
| Considerations | methods for initialization, | efficient item placement |
| | iterative computation, and | strategies without the need |
| | traceback to ensure optimal | for backtracking or iterative |
| | resource allocation over time. | recalculations. |
| Optimization | Focuses on minimizing the | Focuses on minimizing the |
| Metrics | total number of resource units | unused space within bins or |
| | used over time, considering | maximizing the space |
| | both allocation efficiency and | utilization per bin. |
| | penalty for changes | |

For a more comprehensive grasp of the present invention, above is a table comparing the present invention (TS-DPBP) with the traditional bin-packing algorithm across several key features and aspects.

The objective of the present invention is to minimize the total number of GPUs used over time while satisfying each workload's demand at every time slot. In contrast, the traditional bin-packing algorithm aims to minimize the number of bins (containers) used. The present invention involves a higher complexity due to the need to consider the temporal dimension and dynamic workload demands, whereas the traditional bin-packing algorithm is simpler, focusing on spatially packing items without considering time.

When it comes to penalty for reallocations, the present invention takes this into account, making it suitable for dynamic environments with fluctuating demands over time, such as cloud computing resource allocation. On the other hand, the traditional bin-packing algorithm does not typically address penalties for reallocations, making it best suited for static scenarios where the goal is to optimize spatial utilization, like packing goods for shipping.

Implementation considerations differ significantly between the two approaches. The present invention focuses on minimizing the total number of resource units used over time, considering both allocation efficiency and the penalty for changes. In contrast, the traditional bin-packing algorithm focuses on minimizing unused space within bins or maximizing the space utilization per bin.

To provide a comprehensive understanding of the present invention, the following is a simplified pseudo code representation to illustrate the implementation approach of the present invention:

```
def ts_dpbp(i, j, W):
  “““
  Recursive Time Series Dynamic Programming Bin Packing (TS-DPBP)
algorithm.
  Parameters:
  i (int): Number of workloads.
  j (int): Number of time slots.
  W (list): Workload/resource demand matrix of workloads at different time
slots.
    Returns:
  int: Minimal computing power needed to satisfy all workloads over time.
  ”””
    # i: Number of workloads
    # j: Number of time slots
    # W: Resource demand of workloads at different time slots
    # Recursively Fill DP table
    DP[i][j] = min (DP[i][j], ts_dpbp(i−1, j, W) + h (W, i, j), ts_dpbp(i, j−1, W)
+ g (W, i, j))
      # Return the minimal computing power needed to satisfy all
workloads over time
  return DP[i][j]
def ComputingPowerNeeded(A, i, j):
  “““
```

Simulate computation of additional computing power used based on allocation decisions.

```
    Parameters:
    W (list): Workload/resource demand matrix.
    i (int): Workload index.
    j (int): Time slot index.
    Returns:
    int: Additional computing power needed including resource use and other
costs like relocation.
    “““
# Calculate additional Computing Power used based on the proposed
Allocation table in g( )or h( ). The Computing Power used will be the sum of
resources used plus other cost, such as relocation cost, or re-scaling cost, etc.
    return ExtraComputingPower;
def h (W, i, j):
    ”””
    Calculate additional computing power for placement of workload i
through time slot j.
    Parameters:
    W (list): Workload/resource demand matrix.
    i (int): Workload index.
    j (int): Time slot index.
    Returns:
    int: Computed additional computing power based on the allocation table.
    “““
    #Placement search for workload i (the whole time series through time slot
j) ; Update Allocation Table A[i][j][w][t][r]
    return ComputingPowerNeeded(A,i,j)
  def g (W, i, j):
    ”””
    Calculate additional computing power for all workloads up to the given
time slot j.
    Parameters:
    W (list): Workload/resource demand matrix.
    i (int): Workload index.
    j (int): Time slot index.
    Returns:
    int: Computed additional computing power based on the allocation table.
    “““
    # Placement of all workloads for time slots j; Update Allocation Table
A[i][j][w][t][r]
    return ComputingPowerNeeded(A,i,j)
  # Example usage:
  # Define R, C, T, N and W based on the specific scenario
# R: Number of resources
# C: Capacity of each resource
# T: Number of time slots
# N: Number of workloads
# W: Resource demand of workloads at different time slots (e.g., W[i][j])
# A[i][j][w][t][r]: Allocation table A[w][t][r] for DP[i][j]
# Initialize DP table
# DP = [float(‘inf’)] * (T + 1) for _ in range (N + 1)]
# for j in range (T + 1):
# DP[0][j] = Max
# for i in range (N + 1):
# DP[i][0] = Max
  # DP[N][T] = ts_dpbp(R, C, T, N, W)
```

According to the present embodiment, the invention incorporates heuristic techniques to manage the computational complexity typically associated with dynamic programming. These heuristics help approximate optimal solutions efficiently, thereby speeding up computation without exhaustive searches. The heuristic methods include a mix of greedy algorithms and best-fit strategies, which rapidly find near-optimal solutions while balancing the trade-off between solution quality and computational speed. This approach reduces computational complexity and achieves near-optimal practical solutions for real-time applications in dynamic environments such as cloud computing and data centers.

The heuristic combines several strategies, including greedy algorithms, best-fit heuristics, and simplifications of the dynamic programming transitions, tailored to handle time-varying demands efficiently. The goal is to simplify the decision-making process by approximating the dynamic programming steps through more straightforward, less computationally intensive methods.

The heuristic pseudo code operates as follows: Initialization sets up an empty allocation matrix for all workloads across all time slots for each resource. Workloads are then sorted by their maximum demand to prioritize those with the highest resource needs. The algorithm iterates over each workload, attempting to fit it into the least filled resource using a best-fit approach. If a workload does not fit into existing allocations, the algorithm flags an error or handles overflow based on predefined logic. By focusing on the most demanding workloads first and using a best-fit strategy, this heuristic minimizes gaps in resource utilization, reducing computational overhead compared to the full dynamic programming approach. Although this heuristic simplifies the allocation process, making it faster and more adaptable to real-time conditions, it may risk not consistently achieving a globally optimal solution. However, in practical applications, the efficiency and speed of the heuristic can provide substantial benefits, especially in environments where response time and adaptability are critical.

Overall, this heuristic approach aims to efficiently manage resource allocation in dynamic environments by combining various strategies to reduce computational complexity while maintaining high-quality solutions.

Below is the pseudo code for the heuristic approach:

```
def ts_dpbp_heuristic(R, C, T, N, W):
  # R: Number of resources
  # C: Capacity of each resource
  # T: Number of time slots
  # N: Number of workloads
  # W[i][j]: Resource demand of workload i at time j
  # Initialize resource allocation array
  allocation = [[[0 for _ in range(R)] for _ in range(T)] for _ in range(N)]
  # Sort workloads based on their maximum demand across all time slots
  sorted_workloads = sorted(range(N), key=lambda i: max(W[i]),
reverse=True)
    # Allocate resources using First-Fit Decreasing
  for i in sorted_workloads:
    for t in range(T):
      placed = False
      for r in range(R):
        if sum(allocation[k][t][r] for k in range(N)) + W[i][t] <= C:
          allocation[i][t][r] = W[i][t]
          placed = True
          Break
# Review allocation for all t within workload i, find
# the r that has the largest number, try
  # to relocate workload i for all t to this r,
# and making sure all time series to stay in one
# resource through the whole time slots if possible
# if a time series must be split, a penalty can be
# included.
      if not placed:
        raise Exception(“Not enough resources to allocate workload”)
  # Calculate total resource usage
  total_usage = 0
  for t in range(T):
    for r in range(R):
      total_usage += sum(allocation[i][t][r] for i in range(N))
  return total_usage, allocation
# Example usage:
# Define R, C, T, N and W based on the specific scenario
# result, allocation = ts_dpbp_heuristic(R, C, T, N, W)
```

Below is an example of how future workload demands can be predicted via multi-layer correlations. It could be predicted by the following steps: a) deploy and install an application on multiple nodes; b) periodically collect workloads of the application and resource usage in the nodes, and calculate correlation values of resource usage for the application and the sub-application; c) use a time series model to predict the application's workload at a future time point (T+1) based on the current time point (T) and the past time points (T−1, T−2, . . . . T−n) and identify resources with high correlation values above a specified threshold; and d) develop a predictive model for resource usage which uses past resource usage data and predicted application workload at time point T+1 to estimate resource usage increments for the identified resource from step c. Specifically speaking, the correlation values are calculated by measuring similarity using collected resource usage and application workloads, if the similarity value is negative, consider its absolute value, wherein the similarity value is derived from cosine calculations using vectors composed of changes in resource usage and application workloads over three consecutive time points.

The present invention represents a significant leap forward in resource allocation, specifically designed for environments characterized by variable and time-sensitive resource demands. This patent application outlines an innovative method that intelligently merges dynamic programming with time series predictive analytics to dynamically and effectively allocate resources, such as GPUs, in computational settings.

At the core of the present invention is its transformative impact on traditional static resource allocation methods. By introducing a dynamic and adaptive process, it anticipates future resource requirements and adjusts allocations proactively. This capability is particularly critical in applications like training Large Language Models (LLMs), where optimal GPU utilization directly influences operational efficiency and cost-effectiveness. By avoiding both underutilization from over-provisioning and inefficiencies during demand spikes, the present invention minimizes resource wastage and optimizes infrastructure costs.

Moreover, the versatility of the present invention enables seamless integration across diverse technological environments, spanning from small-scale operations to large-scale data centers. This flexibility empowers organizations of all sizes to enhance resource management without necessitating extensive system overhauls or substantial investments.

In summary, the present invention is poised to establish a new standard in resource allocation strategies. By offering a predictive, responsive, and efficient approach that meets the dynamic demands of modern computational technologies, it has the potential to bring widespread improvements in resource management. This innovation not only enhances the capabilities of current systems but also paves the way for future advancements in resource management technologies, fostering operational efficiency, cost reduction, and environmental sustainability in computational infrastructures.

The Time Series Dynamic Programming Bin Packing (TS-DPBP) method of the present invention is particularly effective for environments requiring efficient GPU resource management. This method is applied in various scenarios, such as optimizing GPU resources for training Large Language Models (LLMs) and addressing Environmental, Social, and Governance (ESG) considerations. For LLM training, cloud service providers use TS-DPBP to dynamically allocate GPU resources based on predictive analysis, reducing idle GPUs and preventing bottlenecks during fluctuating demand. In sustainability and ESG compliance, data centers utilize this method to minimize energy consumption by scaling GPU power usage according to demand, thereby supporting carbon footprint reduction goals. For infrastructure efficiency, multinational corporations employ TS-DPBP to match GPU allocation with workload needs, reducing physical server use, space, heat generation, and air conditioning demand while streamlining network traffic. In cost reduction and operational efficiency, AI research facilities manage tight budgets by dynamically adjusting GPU resources in real time, maximizing utilization rates and reducing costs per training session. Overall, TS-DPBP enhances operational efficiency, supports ESG goals, and optimizes infrastructure utilization in environments with variable and unpredictable resource demands.

It is to be understood that the specific order or hierarchy of steps in the methods disclosed is an illustration of exemplary processes and may be rearranged based upon design preferences. The accompanying method claims present elements of the various steps in a sample order, and are not meant to be limited to the specific order or hierarchy presented unless specifically recited therein.

Although embodiments have been described herein with respect to particular configurations and sequences of operations, it should be understood that alternative embodiments may add, omit, or change elements, operations and the like. Accordingly, the embodiments disclosed herein are meant to be examples and not limitations.

What is claimed is:

1. A method for dynamically optimizing resource allocation in a computational environment, comprising the steps of:
collecting current state data of resources within the computational environment;
calculating minimum computing power required to satisfy all workloads over time based on transitions of the current state data using dynamic programming;
generating an allocation table, a three-dimensional array, to represent workloads across time slots for each resource, based on the collected current state data and the calculated minimum computing power, wherein each cell in the allocation table indicates resource utilization of a specific workload during the corresponding time slot;
determining whether to allocate a predicted workload within current allocation across various time slots or to reallocate workloads over an extended number of time slots to fulfill future resource demand of the predicted workload, based on which option requires less additional computing power; and
dynamically adjusting resource allocations across the time slots based on the allocation decision of the predicted workload and the future resource demands of the predicted workload to optimize resource efficiency and minimize operational costs.

2. The method according to claim 1, wherein the future resource demands are predicted by collecting and analyzing current and historical resource usage data and trends using time-series predictive analysis.

3. The method according to claim 1, wherein the resource allocations are adjusted based on a workload/resource demand matrix of workloads at different time slots and the allocation table, both of which are dynamically updated after the adjustment of resource allocations to detail workloads across different time slots for each resource in real-time.

4. The method according to claim 1, wherein each resource is subdivided into virtual units and individually listed in the allocation table to display the workload for each time slot within each virtual unit.

5. The method according to claim 1, wherein each time slot represents a distinct decision point, where decisions are made based on state transition logic that combines the current state with predicted future states.

6. The method according to claim 1, wherein the current state data includes resource allocation, available resource capacity, total number of time slots, total number of workloads, and resource demand of each workload per time slot at the time the data is collected.

7. The method according to claim 1, wherein the allocation decision is determined by comparing the minimum additional computing power needed to accommodate a new workload across all time slots with the minimum additional computing power required to reallocate all workloads from one time slot to another, while also considering the extra cost of placing the same workload in different resources across various time slots.

8. The method according to claim 1, wherein the workloads are allocated using a bin-packing like process applied to a time-series.

9. The method according to claim 1, wherein the computing power includes the sum of resources used, relocation cost, and re-scaling cost.

10. The method according to claim 1, wherein the resources within the computational environment include GPUs, CPUs, memories, storage devices, virtual machines and containers, software resources, and cloud resources.

11. A system for dynamically optimizing resource allocation in a computational environment, comprising:
a plurality of resources within the computational environment;
a data collecting module, connected to the plurality of resources, for continuously collecting current state data of resources within the computational environment in real-time;
a workload prediction module, connected to the data collecting module, for predicting future resource demands of a predicted workload;
a management module, connected to the data collecting module and the workload prediction module, for calculating minimum computing power required to satisfy all workloads over time based on transitions of the current state data using dynamic programming; generating an allocation table, a three-dimensional array, to represent workloads across time slots for each resource, based on the collected current state data and the calculated minimum computing power, wherein each cell in the allocation table indicates resource utilization of a specific workload during the corresponding time slot; and determining whether to allocate the predicted workload within current allocation across various time slots or to reallocate workloads over an extended number of time slots to fulfill future resource demand of the predicted workload, based on which option requires less additional computing power; and
a dynamic adjustment module, connected to both the management module and the data collecting module, for dynamically adjusting resource allocations across the time slots based on the allocation decision of the predicted workload and the future resource demands of the predicted workload, to optimize resource efficiency and minimize operational costs.

12. The system according to claim 11, wherein the future resource demands are predicted by collecting and analyzing current and historical resource usage data and trends using time-series predictive analysis.

13. The system according to claim 11, wherein the resource allocations are adjusted based on a workload/resource demand matrix of workloads at different time slots and the allocation table, both of which are dynamically updated after the adjustment of resource allocations to detail workloads across different time slots for each resource in real-time.

14. The system according to claim 11, wherein each resource is subdivided into virtual units and individually listed in the allocation table to display the workload for each time slot within each virtual unit.

15. The system according to claim 11, wherein each time slot represents a distinct decision point, where decisions are made based on state transition logic that combines the current state with predicted future states.

16. The system according to claim 11, wherein the current state data includes resource allocation, available resource capacity, total number of time slots, total number of workloads, and resource demand of each workload per time slot at the time the data is collected.

17. The system according to claim 11, wherein the allocation decision is determined by comparing the minimum additional computing power needed to accommodate a new workload across all time slots with the minimum additional computing power required to reallocate all workloads from one time slot to another, while also considering the extra cost of placing the same workload in different resources across various time slots.

18. The system according to claim 11, wherein the workloads are allocated using a bin-packing process applied to a time-series.

19. The system according to claim 11, wherein the computing power includes the sum of resources used, relocation cost, and re-scaling cost.

20. The system according to claim 11, wherein the resources within the computational environment include GPUs, CPUs, memories, storage devices, virtual machines and containers, software resources, and cloud resources.
